(19) United States
(12) Patent Application Publication
(10) Pub. No.: US 2014/0101316 A1
(43) Pub. Date: Apr. 10, 2014

(54) APPARATUS AND METHOD FOR PROVISIONING

(71) Applicant: Electronics and Telecommunications Research Institute, (US)

(72) Inventors: Tae Ho LEE, Daejeon (KR); Jae Gi LEE, Daejeon (KR); Taesang CHOI, Daejeon (KR)

(73) Assignee: Electronics and Telecommunications Research Institute, Daejeon (KR)

(21) Appl. No.: 13/838,597

(22) Filed: Mar. 15, 2013

(30) Foreign Application Priority Data
Oct. 8, 2012 (KR) 10-2012-0111351

(51) Int. Cl. H04L 12/24

(52) U.S. Cl. CPC H04L 41/08
USPC 709/226

(57) ABSTRACT

A provisioning management apparatus for a cloud data center collects cloud resource information including at least resource form information and performance measurement information of a cloud, determines a present resource state of the cloud data center using the collected cloud resource information, calculates a theoretical optimal resource reservation based on the present resource state, configures a resource of the cloud data center when the theoretical optimal resource reservation accepts a user request, and verifies the resource configuration.

### CROSS-REFERENCE TO RELATED APPLICATION

This application claims priority to and the benefit of Korean Patent Application No. 10-2012-0111351 filed in the Korean Intellectual Property Office on Oct. 8, 2012, the entire contents of which are incorporated herein by reference.

### BACKGROUND OF THE INVENTION

(a) Field of the Invention

The present invention relates to a method and apparatus for provisioning. More particularly, the present invention relates to a method and apparatus for provisioning for a cloud data center.

(b) Description of the Related Art

A cloud service provider provides a cloud computing function to a cloud service consumer using a cloud data center thereof.

In order to efficiently use the cloud data center, management technology such as provisioning, failure management, and monitoring is necessary. In order to optimize a cloud resource, provisioning in the cloud data center provides a function of resource availability analysis, readjustment of a configured resource, and resource allocation and notification according to a new request. However, a function of determining whether corresponding provisioning is appropriately performed, i.e., whether a provisioned network provides an expected performance level, is not provided.

### SUMMARY OF THE INVENTION

The present invention has been made in an effort to provide a method and apparatus for provisioning having advantages of determining whether a provisioned network provides an expected performance level.

An exemplary embodiment of the present invention provides a provisioning apparatus for a cloud data center. The provisioning apparatus includes: a resource availability analysis unit, a resource allocation scheduling unit, and a resource provisioning unit. The resource availability analysis unit collects cloud resource information and determines a present resource state using the collected cloud resource information. The resource allocation scheduling unit calculates a theoretical optimal resource reservation based on the present resource state, and determines whether the theoretical optimal resource reservation accepts a user request. The resource provisioning unit configures a resource of the cloud data center if the theoretical optimal resource reservation accepts a user request.

The provisioning apparatus may further include a verification unit that verifies a resource configuration of the cloud data center.

The verification unit may perform verification through whether the resource configuration actually provides a service level agreement (SLA) that is promised to a user.

The resource provisioning unit may adjust the resource configuration if the verification has failed, and the verification unit may again verify the resource configuration according to the user request.

The resource provisioning unit may adjust at least a portion of the resource configuration according to a level at which the resource configuration actually provides an SLA that is promised to a user.

The resource provisioning unit may adjust at least a portion of the resource configuration according to a change level of a network.

The cloud resource information may include resource form information and performance measurement information of a cloud, and the resource availability analysis unit may receive the resource form information and the performance measurement information of the cloud from a resource management function module and a performance management function module, respectively.

Another embodiment of the present invention provides a provisioning method for a cloud data center in a provisioning management apparatus. The provisioning method includes: collecting cloud resource information including at least resource form information and performance measurement information of a cloud; determining a present resource state of the cloud data center using the collected cloud resource information; calculating a theoretical optimal resource reservation based on the present resource state; determining whether the theoretical optimal resource reservation accepts a user request; configuring, if theoretical optimal resource reservation accepts the user request, a resource of the cloud data center; and verifying a resource configuration of the cloud data center.

The verifying of a resource configuration may include verifying the resource configuration according to whether an SLA is provided to a user.

The verifying of a resource configuration may include adjusting, if verification of the resource configuration has failed, at least a portion of the resource configuration.

The provisioning method may further include adjusting, when a request for a change of a network that is generated by the resource configuration is received from a user, at least a portion of the resource configuration according to a change level of the network.

### BRIEF DESCRIPTION OF THE DRAWINGS

FIG. 1 is a diagram illustrating a cloud computing environment to which the present invention is applied.

FIG. 2 is a diagram illustrating a cloud management device according to an exemplary embodiment of the present invention.

FIG. 3 is a flowchart illustrating operation of a provisioning function module that is shown in FIG. 2.

FIG. 4 is a block diagram illustrating a configuration of a provisioning function module that is shown in FIG. 2.

FIG. 5 is a diagram illustrating a provisioning method in a cloud management device according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Hereinafter, a method and apparatus for provisioning according to an exemplary embodiment of the present invention will be described in detail with reference to the drawings.

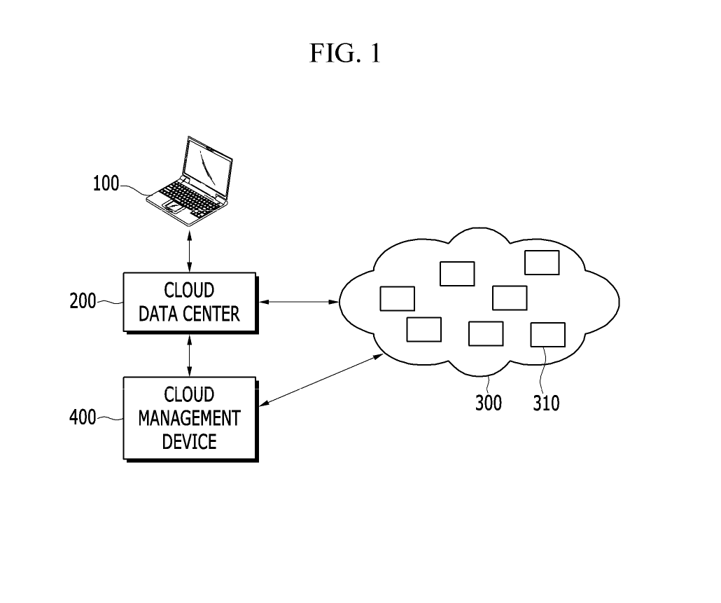

FIG. 1 is a diagram illustrating a cloud computing environment to which the present invention is applied.

As shown in FIG. 1, a user terminal 100 is connected to a cloud data center 200, and the cloud data center 200 stores and manages data to provide it to the user terminal 100. The cloud data center 200 provides a cloud computing function to the user terminal 100 using a plurality of nodes 310, which are a resource of a network 300. Particularly, the cloud data center 200 generates a virtual resource of a physical resource of the network 300 using server virtualization and provides a cloud computing function to the user terminal 100 using the virtual resource. The node 310 of the network 300 includes communication equipment such as a router or a switch and a server.

In this way, when using virtualization, efficiency of the cloud data center 200 can be maximized, and from an operation viewpoint of the cloud data center 200, autonomy and flexibility can be provided.

A cloud management device 400 manages the network 300 and a resource and a service of the network 300 in a cloud computing environment.

Further, when the cloud management device 400 manages the network 300 and a resource and a service of the network 300, the cloud management device 400 supports an autonomic function. That is, the cloud management device 400 minimizes a manager's intervention, thereby performing self-regulating management.

The cloud management device 400 is not limited to a specific type of cloud data center 200, and can be applied to a mode type of cloud data center 200, and can be applied to a general data center as well as a cloud computing environment of FIG. 1.

The cloud data center 200 provides a service that is appropriate to a user request. A request form of the user represents a service of a form desired to receive when the user uses the cloud data center 200. In an IaaS cloud, a user request includes the number and a performance of a node that the user requires and network topology that combines these with a specific method.

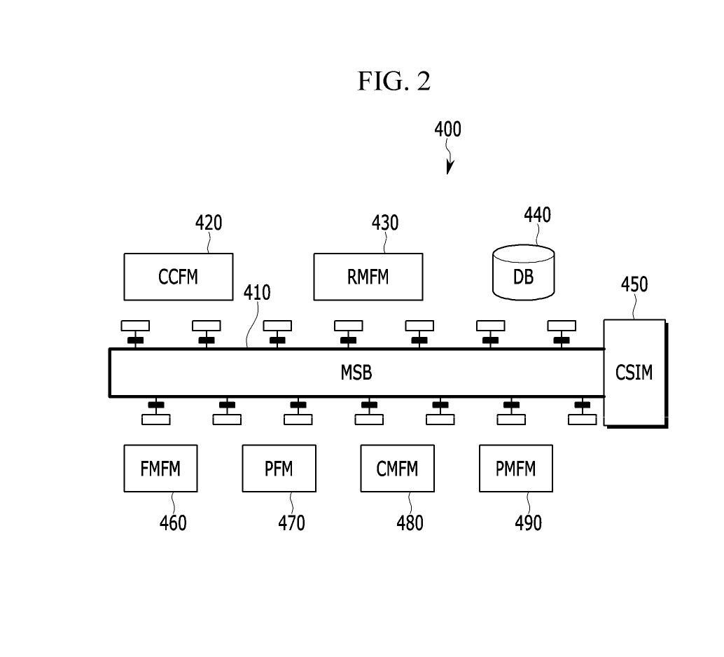

FIG. 2 is a diagram illustrating a cloud management device according to an exemplary embodiment of the present invention.

Referring to FIG. 2, the cloud management device 400 includes a message service bus (MSB) 410 corresponding to an interface module, a common criteria function module (CCFM) 420, a resource management function module (RMFM) 430, a database (DB) 440, a common service interface module (CSIM) 450, a fault management function module (FMFM) 460, a provisioning function module (PFM) 470, a cognitive management function module (CMFM) 480, and a performance monitoring function module (PMFM) 490.

The MSB 410 provides an interface between the function modules 420-490 of the cloud management device 400 through a message. The function modules 420-490 of the cloud management device 400 exchange information through a message that is transferred through the MSB 410. The message that is transferred through the MSB 410 provides a consistent interface for the function modules 420-490 of the cloud management device 400, and operates through a subscribe/publish method. For example, when the PFM 470 is interested in information of the PMFM 490, the PFM 470 subscribes to the PMFM 490, and when the PMFM 490 publishes information, the PFM 470 receives desired information of the PMFM 490 through the MSB 410.

The CCFM 420 provides authentication for the cloud data center 200. Here, authentication is not limited to a user of the cloud data center 200. A node that is added to the cloud data center 200 should also be authenticated, and it should be authenticated whether a network is a logical network that is generated by a user or a physical network of the cloud data center 200. Further, a service that is provided in the cloud data center 200 should also be authenticated. Therefore, the CCFM 420 performs node authentication, network authentication, and service authentication that is added to the cloud data center 200 as well as user authentication of the cloud data center 200.

The RMFM 430 manages a resource of the cloud data center 200 such as a switch, a router, and a server. The RMFM 430 finds a resource of the cloud data center 200, monitors a form of each resource such as a failure or a disorder, and analyzes a form of each resource. The RMFM 430 stores a found resource list and analyzes form information of each resource at the DB 440 through the MSB 410.

Further, when an error such as a failure or a disorder occurs, the RMFM 430 receives a relief policy that is generated by the FMFM 460 and again configures a resource of the cloud data center 200 according to the received relief policy.

The FMFM 460 detects an error, separates and analyzes an essential cause, and generates a relief policy regarding the detected error. The type of an error is not limited to an apparatus error such as a power failure or an apparatus failure. The error includes all types of SLA violations of a final user such as high delay of a link and large jitter.

The FMFM 460 interacts with the CMFM 480 for understanding of a high level regarding an error while analyzing the error. For example, when a cloud failure occurs, the CMFM 480 receives symptoms regarding a failure from the FMFM 460 and searches for a substantial problem based on such symptoms. Further, in a multi-cloud environment that is formed with different kinds of network equipment, because a set of the same commands that are used for a router may be different commands in Cisco and Juniper routers, understanding and analysis of such a difference is included in a function of the CMFM 480.

Further, in order to receive additional information for analysis of an error, the FMFM 460 interacts with the RMFM 430 and the PMFM 490. That is, the FMFM 460 requests and receives analyzed form information of each resource from the RMFM 430, requests and receives a performance measurement value of the cloud from the PMFM 490, and analyzes an error using the received information.

When a relief policy is generated, the FMFM 460 transfers the generated relief policy to the RMFM 430. Further, the FMFM 460 stores particulars that are related to an error according to severity of an error at the DB 440 through the MSB 410.

The PMFM 490 performs a function of measuring performance of the cloud. That is, the PMFM 490 monitors and measures computing resource performance, service resource performance, network resource performance, and logical network performance of a user.

The PMFM 490 provides network measurement such as delay statistics or a throughput necessary when determining network performance as well as measuring a simple error such as a power failure. The PMFM 490 provides network measurement for a logical network of the user as well as network measurement of the substrate network of the cloud data center 200.

The other function modules 420, 430, 460, 470, and 480 perform corresponding functions based on information that is measured by the PMFM 490. The PMFM 490 filters only information that is related to the respective function modules 420, 430, 460, 470, and 480 from the measured information and transfers the filtered information to corresponding function modules 420, 430, 460, 470, and 480.

Further, the PMFM 490 stores corresponding information at the DB 440 and performs communication between the PMFM 490 and the respective function modules 420, 430, 460, 470, and 480 through the MSB 410.

The CMFM 480 is a module that provides intelligence to the cloud management device 400. A core function of the CMFM 480 is to perform better cloud management by cooperating with the above-described function modules 420, 430, 460, 470, and 490. That is, the CMFM 480 analyzes context related information that is provided by the respective function modules 420, 430, 460, 470, and 490 and generates information that the respective function modules understand and require. That is, the CMFM 480 performs a central function in providing intelligence or autonomy to the cloud management device 400.

Next, a goal of the PFM 470 is to perform many user requests, if possible, with an efficient method. For this purpose, the PFM 470 collects available cloud resource information through cooperation with the DB 440, the RMFM 430, and the PMFM 490, and calculates a theoretical optimal resource reservation using the collected cloud resource information. The PFM 470 requests necessary information from the RMFM 430 and the PMFM 490, collects necessary information from the RMFM 430 and the PMFM 490, and searches for necessary information at the DB 440, thereby collecting available cloud resource information.

The PFM 470 configures a resource according to the calculated theoretical optimal resource reservation. After the resource is configured, in order to determine whether a provisioned resource operates like an original intention, the PFM 470 monitors the provisioned resource.

In order for the function modules 430, 460, 470, 480, and 490 to use respective functions, the CSIM 450 provides a basic application program interface (API) and has an in-memory data management function that temporarily stores data that is generated by the function modules 430, 460, 470, and 490.

Information that is generated in the RMFM 430, cloud performance measurement in the PMFM 490, and particulars that are related to an error generated in the FMFM 460 are stored at the DB 440, and information that is stored at the DB 440 is used for reference upon performing resource management or provisioning later.

A manager and a user can access information of the cloud management device 400 such as an original state and error information through an operation and management system. This information may be displayed in the operation and management system by text or graphically.

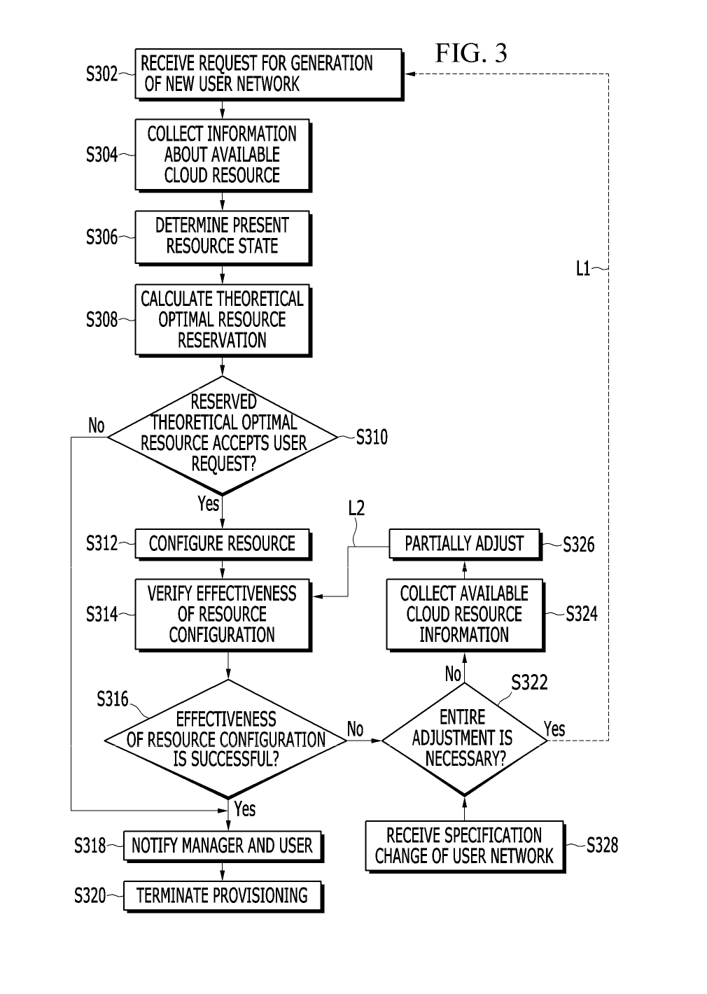

FIG. 3 is a flowchart illustrating operation of a provisioning function module that is shown in FIG. 2.

The provisioning algorithm of the PFM 470 that is shown in FIG. 3 may be triggered by two cases. The two cases are a case where a user requests generation of a new user network and a case where a user changes an existing network.

Referring to FIG. 3, when a request for generation of a new user network is received from the user (S302), the PFM 470 collects information about an available cloud resource from the DB 440, the RMFM 430, and the PMFM 490 through the MSB 410 (S304).

The PFM 470 determines a present resource state based on the collected cloud resource information (S306). For example, the PFM 470 determines a present resource state based on a bandwidth resource in a switch router as well as a CPU resource amount, a memory resource, a storage resource, and a network resource that can be available in the cloud data center 200.

When a present resource state of the cloud data center 200 is determined, the PFM 470 calculates a theoretical optimal resource reservation (S308). At this step, an optimal resource reservation is theoretically calculated, and an actual resource is not changed. Algorithms using theories of several fields such as mathematics/economics may be used for optimal resource reservation calculation, and for example, methods such as preference selection of economic theory as well as a most basic round robin method or water filling method may be used.

In many resource allocation problems from the academic world, this problem has been known to a non-deterministic polynomial-time (NP)-hard problem, and this means that a calculation of an optimal resource reservation is not easy. Therefore, before some actual provisioning is performed, it is necessary to take measures in which an effective theoretical optimal resource reservation can be calculated. Further, at step S308, the PFM 470 may theoretically change a cloud resource configuration existing in order to correspond to a user request.

An output of a calculated theoretical optimal resource reservation of the PFM 470 is a set of commands constituting the cloud corresponding to a user request. As an example, a set of commands may be the same as that of Table 1. The illustration that is shown in Table 1 is for easy understanding, and a set of actual commands may be more complex.

TABLE 1

| | |
|---|---|
| 1. | Create VM |
| | 1. Assign id 0x009273 |
| | 2. Assign 1 GHz of CPU, 1 Gb of Memory, 2Gb of |
| | harddrive |
| | 3. Create one ethernet interface with IP addr of 10.0.0.1 |
| 4. | Install Ubuntu 9.04 operating system |
| 2. | Move VM (0x005938) from Server 1-1 to Server 1-2. |
| 3. | Move VM (0x008930) from Server 2-8 to Server 2-1 |
| 4. | Assign VM (0x009273) to Server 1-1 |
| 5. | Goes on an on |

When a theoretical optimal resource reservation is calculated (S308), the PFM 470 determines whether a reserved theoretical optimal resource accepts a user request (S310).

If a reserved theoretical optimal resource accepts a user request, the PFM 470 generates a set of commands for constituting a resource of the cloud data center 200 based on the theoretical optimal resource and configures a resource of the cloud data center 200 according to the generated set of commands (S312).

In this way, the PFM 470 separates the calculation step of a theoretical optimal resource reservation and the configuration step of an actual resource, and the reason that the PFM 470 separates the calculation step of a theoretical optimal resource reservation and the configuration step of an actual resource is to perform provision that is optimized for a present cloud situation, and by filtering unacceptable SLAs, the PFM 470 can preemptively prevent an unnecessary resource configuration.

If a reserved theoretical optimal resource does not accept a user request at step S310, the PFM 470 notifies the user and the manager of the cloud data center 200 of this (S318) and terminates provisioning (S320).

The PFM 470 configures a resource of the cloud data center 200 and verifies effectiveness of a resource configuration (S314). In this case, effectiveness of a resource configuration is verified by determining a user request. That is, step S314 is a step of determining whether a resource configuration actually transfers an SLA that is promised to the user. For example, the PFM 470 measures a CPU speed or a memory such as a resource of nodes and determines whether the measurement values correspond to a user request, thereby verifying effectiveness of a resource configuration.

In a conventional cloud management device, a step similar to step S314 is performed by the FMFM 460. However, because the FMFM 460 monitors all single user networks existing in a network, a load amount thereof is enormously large. Therefore, as in an exemplary embodiment of the present invention, when the PFM 470 performs step S314, a portion of duty of the FMFM 460 is solved and thus a load amount of the FMFM 460 may be reduced.

Further, because a newly added network may cause a problem that the newly added network cannot satisfy, for example, an estimated SLA level or may provide a lower level than an estimated SLA level, the newly added network may have a negative influence on an already configured user network. Alternatively, a theoretical optimal resource reservation calculation of step S308 may be inaccurate. Therefore, in order to determine integrity of a newly added user network regardless of a cause of an error, it is necessary to verify effectiveness of a resource configuration (S314).

The PFM 470 verifies whether effectiveness of a resource configuration is successful (S316), and if effectiveness of a resource configuration is successful, the PFM 470 notifies the manager and the user of this (S318) and terminates provisioning (S320).

If effectiveness of a resource configuration is not successful, i.e., if a problem occurs in provisioning (S316), the process starts an adjustment routine.

As shown in FIG. 3, the adjustment routine includes a first routine L1 that starts provisioning by returning to step S302 and a second routine L2 that collects cloud resource information through steps S324 and S326 and that partially adjusts the collected cloud resource information and that performs step S314.

The PFM 470 determines severity of a provisioning problem and selects one of the first and second routines L1 and L2 according to the determined severity.

The PFM 470 determines whether entire adjustment is necessary according to the severity of a provisioning problem (S322), and if entire adjustment is necessary according to the severity of a provisioning problem, the process returns to step S302 and the PFM 470 again starts provisioning.

If entire adjustment is unnecessary, the PFM 470 collects information regarding some cloud resource in which a problem has occurred instead of entire cloud resource information (S324), configures a resource through steps S306-S312 using the collected cloud resource information, and partially adjusts the resource configuration (S326).

Thereafter, the PFM 470 again verifies effectiveness of the resource configuration (S314).

The PFM 470 determines whether entire adjustment is necessary according to the severity of a provisioning problem (S322), and if entire adjustment is necessary according to the severity of a provisioning problem, the process returns to step S302 and the PFM 470 again starts provisioning.

In this case, in order to prevent an infinite loop of the provisioning algorithm, the PFM 470 may set the number of routine repetitions. Therefore, until the number of routine repetitions reaches the set number, if provisioning is not successful, the PFM 470 may notify the manager and the user of a provisioning failure and terminate provisioning.

Further, when the user changes a specification of a user network, the PFM 470 receives this (S328) and selects one of the first and second routines L1 and L2 according to a change level of the network. A method of selecting one of the first and second routines L1 and L2 may be the same method as that of the foregoing description. That is, if a small adjustment is necessary according to a change level of a network, the PFM 470 selects the second routine L2, and otherwise may select the first routine L1.

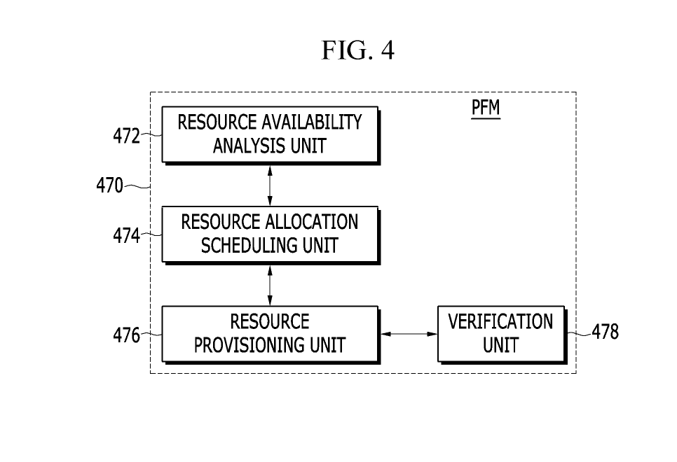

FIG. 4 is a block diagram illustrating a configuration of a provisioning function module that is shown in FIG. 2.

Referring to FIG. 4, the PFM 470 includes a resource availability analysis unit 472, a resource allocation scheduling unit 474, a resource provisioning unit 476, and a verification unit 478.

When a request for generation of a new user network is received from the user, the resource availability analysis unit 472 collects cloud resource information that is related to a resource of the cloud data center 200 from the DB 440 and the PMFM 490.

The resource availability analysis unit 472 determines a present resource state of the cloud data center 200 from available cloud resource information.

The resource allocation scheduling unit 474 calculates a theoretical optimal resource reservation based on a present resource state of the cloud data center 200. That is, the resource allocation scheduling unit 474 calculates an optimal resource reservation based on provisioning knowledge information of the CSIM 450, and generates a set of theoretical commands for configuring a resource based on the calculated optimal resource reservation.

The resource provisioning unit 476 configures a resource of the cloud data center 200 according to a set of theoretical commands.

After a resource of the cloud data center 200 is configured, the verification unit 478 verifies effectiveness of a resource configuration. The verification unit 478 verifies whether a resource configuration actually provides an SLA that is promised to the user.

The verification unit 478 notifies the manager and the user of a verification result of effectiveness of the resource configuration.

When verification of the resource configuration has failed in the verification unit 478, the resource provisioning unit 476 determines severity of a provisioning problem and determines a restart of provisioning or determines adjustment of the resource configuration.

When adjustment of the resource configuration is determined, the resource provisioning unit 476 theoretically adjusts an existing resource configuration using available cloud resource information that is collected in the resource availability analysis unit 472. Thereafter, the verification unit 478 again verifies effectiveness of an adjusted resource configuration.

Further, when the resource provisioning unit 476 receives a request for a change of a user network from the user, the resource provisioning unit 476 determines a restart of provisioning or determines adjustment of the resource configuration.

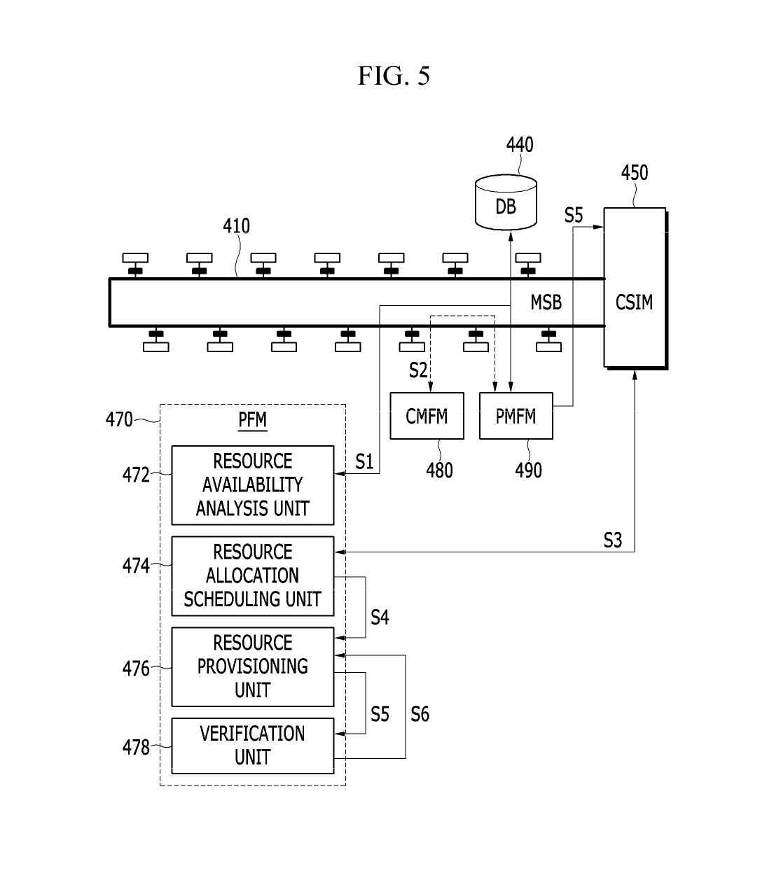

FIG. 5 is a diagram illustrating a provisioning method in a cloud management device according to an exemplary embodiment of the present invention.

Referring to FIG. 5, when the PFM 470 receives a user request, the PFM 470 collects cloud resource information that is related to a resource state of the cloud data center 200. The PFM 470 requests information that is related to a resource state from the DB 440 and the PMFM 490 through the MSB 410, and collects cloud resource information that is related to the resource state through a process of receiving information that is related to the resource state from the DB 440 and the PMFM 490 (S1).

When the PMFM 490 generates information that is requested from the PFM 470, in order to generate useful information about network statistics, the PMFM 490 cooperates with the CMFM 480 when analyzing network resource information data (S2). The PMFM 490 temporarily stores corresponding information at the CSIM 450 until the PFM 470 is prepared to receive information.

The resource availability analysis unit 472 of the PFM 470 determines a present resource state of the cloud data center 200 using cloud resource information, and when a present resource state of the cloud data center 200 is completely determined, the resource availability analysis unit 472 generates a command for constituting a resource based on provisioning knowledge information in the resource allocation scheduling unit 474 (S3). The resource provisioning unit 476 of the PFM 470 configures a resource according to a generated command set, and if a resource configuration is theoretically possible, the resource provisioning unit 476 of the PFM 470 configures a resource based on the generated command set (S4). In this case, while a resource is configured based on a command set, cooperation of provisioning knowledge information of the CSIM 450 and the CMFM 480 may be necessary.

Thereafter, the verification unit 478 of the PFM 470 verifies a provisioning resource (S5), and the resource provisioning unit 476 may adjust the resource configuration, as needed, according to a verification result (S6).

Finally, the verification unit 478 of the PFM 470 notifies the user and the manager of the verification result of provisioning.

According to an exemplary embodiment of the present invention, by verification of whether corresponding provisioning is appropriately performed, performance of a provisioned resource can be guaranteed.

Further, as a verification function is separated from a failure management function, improved performance can be provided, and a workload of a failure management system of a cloud data center can be relieved.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A provisioning apparatus for a cloud data center, the provisioning apparatus comprising:
a resource availability analysis unit that collects cloud resource information and that determines a present resource state using the collected cloud resource information;
a resource allocation scheduling unit that calculates a theoretical optimal resource reservation based on the present resource state and that determines whether the theoretical optimal resource reservation accepts a user request; and
a resource provisioning unit that configures a resource of the cloud data center if the theoretical optimal resource reservation accepts a user request.

2. The provisioning apparatus of claim 1, further comprising a verification unit that verifies a resource configuration of the cloud data center.

3. The provisioning apparatus of claim 2, wherein the verification unit performs verification through whether the resource configuration actually provides a service level agreement (SLA) that is promised to a user.

4. The provisioning apparatus of claim 3, wherein the resource provisioning unit adjusts the resource configuration if the verification has failed, and
the verification unit again verifies the resource configuration according to the user request.

5. The provisioning apparatus of claim 3, wherein the resource provisioning unit adjusts at least a portion of the resource configuration according to a level at which the resource configuration actually provides an SLA that is promised to a user.

6. The provisioning apparatus of claim 2, wherein the resource provisioning unit adjusts at least a portion of the resource configuration according to a change level of a network.

7. The provisioning apparatus of claim 1, wherein the cloud resource information comprises resource form information and performance measurement information of a cloud, and
the resource availability analysis unit receives the resource form information and the performance measurement information of the cloud from a resource management function module and a performance management function module, respectively.

8. A provisioning method for a cloud data center in a provisioning management apparatus, the provisioning method comprising:
collecting cloud resource information comprising at least resource form information and performance measurement information of a cloud;
determining a present resource state of the cloud data center using the collected cloud resource information;
calculating a theoretical optimal resource reservation based on the present resource state;
determining whether the theoretical optimal resource reservation accepts a user request;
configuring, if theoretical optimal resource reservation accepts the user request, a resource of the cloud data center; and
verifying a resource configuration of the cloud data center.

9. The provisioning method of claim 8, wherein the verifying of a resource configuration comprises verifying the resource configuration according to whether an SLA is provided to a user.

10. The provisioning method of claim 8, wherein the verifying of a resource configuration comprises adjusting, if verification of the resource configuration has failed, at least a portion of the resource configuration.

11. The provisioning method of claim 8, further comprising adjusting, when a request for a change of a network that is generated by the resource configuration is received from a user, at least a portion of the resource configuration according to a change level of the network.
